(19) United States
(12) Patent Application Publication
(10) Pub. No.: US 2007/0183569 A1
(43) Pub. Date: Aug. 9, 2007

(54) Method for graphically following a movement of a medical instrument introduced into an object under examination

(76) Inventors: Jan Boese, Eckental (DE); Marcus Pfister, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/704,410

(22) Filed: Feb. 8, 2007

(30) Foreign Application Priority Data
Feb. 9, 2006 (DE) 10 2006 006 038.5

(51) Int. Cl. G01N 23/04; H05G 1/02

(52) U.S. Cl. 378/62; 378/196

(57) ABSTRACT

The invention relates to an apparatus and a method for graphically following movements of a medical instrument introduced into an object under examination, with a plurality of projection data sets being obtained from an x-ray beam passing through an examination area and delimited by a beam delimiting surface, in which a part of the medical instrument is guided, and with a three-dimensional image data set of the examination area being determined and represented graphically from the projection data sets. By determining three-dimensional image data sets successively with an image determination rate that is selected so that the movement of the medical instrument is able to be followed, the method and the apparatus can follow a moving medical instrument introduced into the examination area over the duration of a medical intervention and guarantee good accessibility to the object.

### CROSS REFERENCE TO RELATED APPLICATIONS

This application claims priority of German application No. 10 2006 006 038.5 filed Feb. 09, 2006, which is incorporated by reference herein in its entirety.

### FIELD OF THE INVENTION

The present invention relates to the improvement of x-ray devices in general, especially in the area of medical technology. In particularly, the invention relates to a device and a method for following in graphical form the movement of a medical instrument introduced at least partly into an object under examination.

### BACKGROUND OF THE INVENTION

Irrespective of development in the area of medical technology, especially in methods of imaging, e.g. computer tomography and magnetic resonance tomography, conventional x-ray systems remain an important instrument for medical diagnosis and patient monitoring. One area in which x-ray examinations are used is diagnostics, e.g. the clarification of bone fractures, tumors, cysts, calcifications, trapped air or also precautionary examinations. Another area in which x-ray systems are used is fluoroscopy, e.g. with angiographic examinations for detecting the vascular system of a patient, for checking medical interventions, localization of medical instruments etc. Reducing the radiation dose required for x-ray examinations for the patient, especially through technical progress, will open up further areas of application for x-ray technology, especially for systems used in interventional angiography.

It is not just two-dimensional images of a patient that can be obtained with modem angiographic apparatus—like the Siemens Axiom Artis. By recording a number of images or projection data sets for the same examination area from different recording directions, spatial representations of an examination area can also be obtained. A single recording pass is sufficient to capture native images of an examination area, e.g. an organ in its anatomical environment, without introduction of contrast media. In this case a C-arm rotates around the examination area for example, with image data sets of the examination area being recorded as it moves. Back projection allows a spatial representation of the examination area to be determined from the recorded images. The plurality of images required to determine a spatial representation however results in an increased radiation load imposed on the object under examination.

An image reconstruction apparatus for an x-ray device as well as a method for local 3D reconstruction of an object area of an object under examination from 2D images of a number of 2D x-ray fluoroscopy images of the object under examination which were detected in a chronological sequence with different known projection geometries with the x-ray device is known from application 10 2004 016 586 A1. The method and the image reconstruction device provide a simple means of reconstructing a 3D image of a moving locally-delimited object area without movement artifacts.

If the aim of the examination is the display of subtraction images, a number of recording passes are necessary to produce these images. To create a subtraction image a mask image is generally recorded first of all, which corresponds to a native recorded image of the region of interest of the object under examination. An image of this area is then recorded after the introduction of contrast means. If these images are subtracted from each other, a subtraction image is obtained. Spatial representations can also be produced from these types of subtraction images if subtraction images are recorded for a number of projection directions.

The spatial representations which are currently able to be determined using angiography systems have occasionally achieved the quality of spatial representations which are obtained using computer tomography. The x-rayed projected surface for determination of spatial representations in such cases as a rule amounts to an area of approximately 400 cm² or 20 cm by 20 cm, whereas the x-rayed area for computer tomography is as a rule restricted to a few square millimeters.

If interventions are performed on critical areas of the body, such as with neurolyses, biopsies of parenchymatose tissue, drainage treatment for pathological fluid accumulations, radiological, interventional pain therapy, TIPSS—Transjugular Intrahepatic PortoSystemic Shunt, percutaneous bile duct drainage, further special therapies, e.g. radio frequency ablation, etc., spatial representations are desirable for improved checking of the intervention, e.g. the penetration of a thin puncture needle into the critical area of the body. To this end a spatial representation of the relevant examination area—with introduced instrument—is determined between two movements of the medical instrument. Thus for example the progress of the introduction of the needle and the puncture of the tissue can be monitored.

Until now the control of medical interventions based on 3D imaging, which need a low-contrast resolution or precise information about the spatial orientation of an instrument, e.g. a needle, in the body, have been undertaken as a rule with computer tomographs. In such cases a layer or a few thin layers of the object under examination are recorded and a spatial representation of the area examined is reconstructed. Disadvantages of the computer tomography method arise from poor patient accessibility, which is restricted during the detection of a cylindrical surface by the medical personnel, and an increased radiation load for the patient since there is no possibility for fluoroscopy, i.e. detecting a two-dimensional projection with a low x-ray dose.

### SUMMARY OF THE INVENTION

The object of the invention is to provide a generic method of the type given at the start which allows a medical instrument introduced into an object under examination to be followed for the duration of a medical intervention and guarantees good access to the object under examination while this is being done.

The invention relates to a device and a method for following in graphical form the movement of a medical instrument introduced at least partly into an object under examination, with a plurality of two-dimensional projection data sets of an examination area of the object under examination identified in each case by a projection direction being detected, in which at least a part of the medical instrument is guided, with a projection data set being obtained from x-ray radiation penetrating the examination area which has a beam center axis extending in the projection direction and is limited by a beam delimiting surface, and with a three-dimensional image data set of the examination area with the part of the medical instrument guided within it being determined and represented graphically from the projection data sets by means of an image reconstruction method.

The object is achieved by a generic method of the type mentioned at the start of this document by determining three-dimensional image data sets successively with an image determination rate, with the image determination rate being selected so that movement of the medical instrument can be followed. This makes it possible to follow in graphical form a medical instrument introduced into an object under examination, with good access being provided to the object under examination. The projection data sets recorded for determining the three-dimensional image data sets can be detected in any given projection direction. The movement of an x-ray emitter generating the x-ray beam for detecting the projection data sets and of an x-ray detector are synchronized with each other in such cases.

For example x-ray emitter and x-ray detector can each be arranged on a movable robot tripod. The robot tripods can move around the object under examination in such a way that projection data sets are detected that are suitable for determination of a three-dimensional image data set of the examination area with or without the medical instrument guided within it. C-arm systems are likewise conceivable for these types of applications. The more quickly a suitable plurality of projection data sets can be detected for determination of a three-dimensional image data set, the higher will be the image determination rate which is selected for the three-dimensional image data sets. Preferably after each change in the position and/or if necessary the orientation of the medical instrument, a spatial representation of the examination area with the medical instrument is determined, to allow a controlled movement of the medical instrument in the examination area. To keep the time for a medical intervention, e.g. a biopsy, as short as possible, it is advantageous to select an image determination rate that is as high as possible. This makes it possible to guide the medical instrument through the examination area quickly yet safely.

Spatial representations of the examination area with the medical instrument are determined and displayed from the three-dimensional image data sets. A spatial representation of the movement of the medical instrument in the examination area, if possible in real time, enhances the safety of the patient, since the position and/or orientation of the medical instrument relative to the anatomical environment in the examination area can be better presented. In such cases the whole of the medical instrument introduced into the examination area can be represented, or also only parts of the medical instrument in the examination area. To this extent for example a biopsy needle can be guided in an even more targeted manner in an examination area, with simultaneous lower strain on the user of the biopsy needle or on he medical personnel.

In an advantageous embodiment of the invention the beam center axes of the plurality of projection data sets lie in a common examination plane passing through the examination area. This allows a conventional apparatus to be used for the method for following the medical instrument shown in the image in the examination area. This includes for example x-ray devices with a rotatably supported C-arm or U-arm, on which an x-ray emitter and an x-ray detector are arranged at opposite ends of the C-arm or U-arm. This means that costs for medical departments are reduced, since the inventive method can be implemented on existing medical devices.

In an advantageous embodiment of the invention the part of the medical instrument represented by the examination area comprises an end of the medical instrument. This enables the examination area which adjoins the introduced end of the medical instrument to be well estimated. The forwards movement of the medical instrument can be adapted to the anatomical circumstances of the examination area in front of the end of the medical instrument, e.g. in speed and direction of advance. If a medical instrument is partly introduced into an examination area, there is a distal end of the instrument as seen by the user of the medical instrument, i.e. an end of the instrument facing away from the user, as well as a proximal end, i.e. an end of the instrument facing towards the user. As a rule—e.g. with catheters and biopsy needles—the end shown is the distal end of the medical instrument.

In a further advantageous embodiment of the invention the x-ray beam is set depending on the medical instrument introduced into the object under examination such that the beam delimiting surface tightly surrounds the part of the medical instrument introduced into the examination area. This enables not only the graphical display of the movements of the medical instrument in the examination area to be achieved, but also reduces the radiation load for the object under examination. The beam delimiting surface of the x-ray beam is adapted to the region of interest of the object under examination, i.e. to the part of a medical instrument of interest guided in the object under examination in its anatomical environment of the object under examination. This means that the x-ray beam only essentially penetrates the region of interest of the object under examination with the part of the introduced medical instrument. After the x-ray beam is set to the region of interest the examination area expediently coincides with the region of interest. In such cases the determination of the region of interest is a matter for the type of medical intervention and also for the judgment of the medical personnel. As a rule the region of interest will be selected such that the medical instrument can be guided with sufficient safety in the object under examination, but the radiation load for the object under examination is kept as low as possible.

This can be achieved for example by embodying the x-ray beam in a conical shape. To change the aperture angle of the conical x-ray beam an aperture with a circular opening can be used, with the size of the aperture opening being adjustable. Alternately x-ray beams embodied as a wedge-shape or pyramid shape can be used. X-ray beams embodied in this way are provided by an adjustable slit-shaped aperture opening or an adjustable rectangular aperture opening. Depending on the orientation of the region of interest of the object under examination, the relevant x-ray beam can be selected for detecting the projection data sets, and the radiation load can thus be kept lower than with conventional detection of the projection data sets without focusing the x-ray beam. Furthermore, by tightly surrounding the desired part of the medical instrument guided in the object under examination by the beam delimiting surface, the duration which is needed for reconstruction of the three-dimensional image data set can be reduced as a result of a smaller volume of data.

In an advantageous embodiment variant of the invention a three-dimensional image data set of an examination environment of the object under examination surrounding the examination area is determined, over which the successively determined three-dimensional image data sets of the examination area are overlaid. The examination environment advantageously has larger dimensions than the examination area. The examination area is continuously detected by projection data sets and associated three-dimensional image data sets are determined. By overlaying the successively determined three-dimensional image data sets with the examination environment preferably determined once—without the medical instrument for example—the orientation of the medical personnel in the object under examination is improved. Through a successive determination of three-dimensional image data sets of the examination area, anatomical changes—such as from pressure of a biopsy needle on a vessel for example—are detected and inserted into the spatial representation of the examination area detected once. This means that the representation as a whole is always up-to-date. To undertake a correct overlaying of the successively determined image data sets, i.e. to overlay these in the correct position and orientation onto the image data set to of the examination environment, an image registration is preferably undertaken. This can be done by one or more identifying anatomical positions or also by additional visible markings applied to the object under examination assigned externally in the detected data sets. Furthermore the overlaying of the three-dimensional image data sets of the examination area and the examination environment leads to a lower volume of data since the entire examination environment with the moving medical instrument does not have to be reconstructed for each spatial representation in order to create a better orientation for the medical personnel in the object under examination. Through the successive detection of an examination area which is smaller than the examination environment the radiation to which the object under examination is subjected is also reduced.

In a further advantageous embodiment of the invention a two-dimensional projection data set is overlaid onto the last three-dimensional image data set determined. The overlaid presentation of the last three-dimensional image data set determined with a two-dimensional projection data set detected afterwards allows the radiation dose to which the object under examination is subjected to be further reduced. In specific cases no spatial representation is necessary to clarify the position and/or orientation of the medical instrument with regard to the anatomy of the examination area. It is sufficient to overlay a two-dimensional projection data set registered in relation to the last three-dimensional image data set determined onto the last three-dimensional image data set determined. This means that it is not necessary to detect a plurality of projection data sets to determine a three-dimensional image data set, which brings with it a reduced radiation load on the object under examination.

In an advantageous embodiment of the invention the x-ray beam is adjusted so that its beam delimiting surface runs approximately through a limit position which has been marked beforehand in a projection data set detected and/or image data set determined. The limit position delimits the examination area and as a rule is defined by the medial personnel. Advantageously the area is defined by marking a position in a projection data set detected and/or in an image data set determined, preferably electronically, on an input/output device. The x-ray beam is preferably set automatically on the basis of the marking made. The limit position in this case can just still be detected by the x-ray beam, just no longer be detected or possibly be partly detected where the limit position has a particular extent. This allows the examination area to be easily defined with reference to the examination object present.

In a further advantageous embodiment of the invention the setting of the x-ray beam is adapted to the respective current position and/or orientation of the medical instrument. To this end, the position and/or if necessary orientation of the medical instrument is determined using a localization method. This can be done by means of an image-based method or also by means of other localization methods, e.g. an electromagnetic localization method etc. This determines the position of the medical instrument, especially the introduced end of the medical instrument. A change in the position of the introduced medical instrument can for example make it necessary to also change the setting of the x-ray beam. Because of the position of the medical instrument determined, the examination area can be changed such that at least the part of the instrument which is of interest can be well detected by the x-rays. The examination area is preferably adapted in an automated manner by feeding the position of the instrument determined to a controller which subsequently sets the recording device for detecting the projection data sets by means of a setting means so that the medical instrument is always detected in the center of the projection data set for example.

In an advantageous embodiment variant of the invention an overlaying of a three-dimensional image data set and a plane data set is presented, with the plane being defined by the current position of the introduced end of the medical instrument and by two selectable points from an image data set determined and/or projection data set detected. The two points selectable from a projection data set and/or image data set expediently define a target section for a part, especially the end of the medical instrument. This can for example be a visible vessel to be punctured in the spatial representation of the examination area. The third point of the plane is specified by the introduced end of the medical instrument. As a rule the two selectable points and the end of the medical instrument do not lie on a straight line, so that a plane can be produced using these points. The plane is used for guiding the medical instrument in the selected target section. An overlaid representation of the plane and the spatial representation of the examination area enable the orientation of the medical personnel and the targeting of the instrument to be improved.

### BRIEF DESCRIPTION OF THE DRAWINGS

Further advantages of the invention emerge from an exemplary embodiment, which will be explained in greater detail below with reference to the drawings, in which

FIG. 1 shows an inventive device for following in graphical form the progress of a movable medical instrument introduced at least partly into an object under examination,

FIG. 2 shows a flowchart to depict the execution sequence of the inventive method,

FIG. 3 shows a spatial representation of an examination environment with overlaid examination area and medical instrument introduced into it as schematic diagrams.

### DETAILED DESCRIPTION OF THE INVENTION

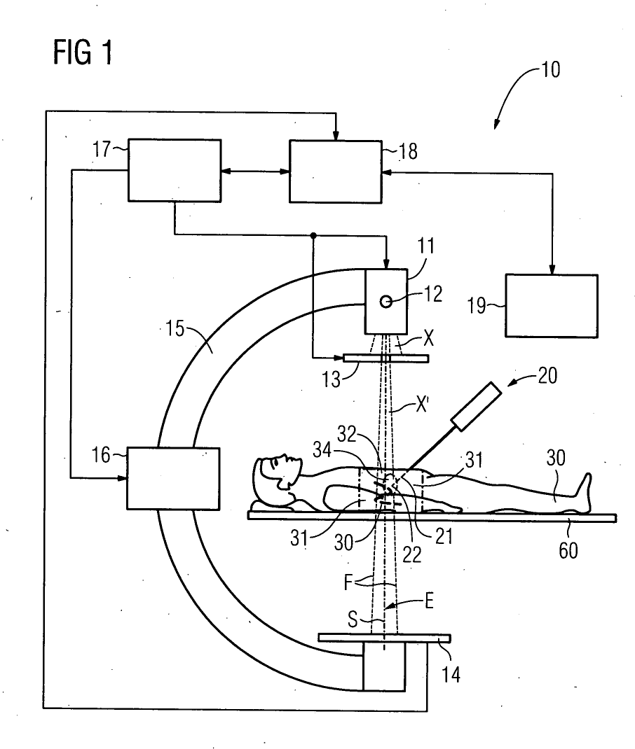

The inventive apparatus 10 depicted in FIG. 1 features an emitter head 11 which comprises an x-ray source 12 for creating of an x-ray beam X. Arranged opposite the emitter head 11 is an x-ray detector 14, with emitter head 11 and x-ray detector 14 being connected by means of a C-arm 15. A focusing device 13 can be used to focus and restrict the x-ray beam X generated by the x-ray source 12 to an x-ray beam component X′. The x-ray beam X′ or X has a beam delimiting surface F. Furthermore the x-ray beam X as well as the focused x-ray beam X′ as a rule have an identical beam center axis S. The beam center axis S specifies the projection direction for the projection data sets of an object under examination 30 detected by means of the x-ray beam X′. A patient table 60 can be arranged between the emitter head 11 and the x-ray detector 14, on which object under examination 30 is positioned during the examination or a medical intervention. The object under examination 30 features an examination area 32, in which there is provision for executing the medical intervention by means of a medical instrument 20. The focused x-ray beam X′ passes through an examination area 32 of the object under examination 30 and detects the state of the examination area 32 in the form of a projection data set. The intervention consists in the exemplary embodiment of the puncturing with a puncture needle 20 of a vessel 33 to be punctured. After introduction of the puncture needle 20 into the object under examination 30 the puncture needle 20 has an introduced part 21. To follow the introduced part 21 of the puncture needle 20 projection data sets of the examination area 32 with the introduced part 21 of the puncture needle 20 are detected or recorded from different projection directions. In this case the x-ray beam X′ is adjusted such that the beam delimiting surface F tightly surrounds the introduced part 21 of the medical instrument 20. This enables a low radiation load on the object under examination 30 to be achieved. A controller 17 controls the detection of the projection data sets, including the projection directions the detection rate for projection data sets as well as the movement of the C-arm 15 and of the components 11 or 13 or 14 attached to the C-arm 15.

The controller 17 controls a drive 16 connected to the C-arm 15, which moves the C-arm 15 into the position specified by the controller 17. For the C-arm x-ray system 10 depicted in FIG. 1 the C-arm 15 is typically rotated such that the x-ray emitter 11 leaves the leaf plane in the direction of the observer and simultaneously the x-ray detector 14 leaves the leaf plane in the line of vision of the observer. The x-ray detector 14 and the x-ray emitter 11 can also be moved in the reverse direction. Alternately the rotation can also occur in the leaf plane in that the C-arm 15 is rotated orbitally around the examination area 32. The drive 16 is also provided for setting the focusing device 13, which spatially limits the x-rays X emitted by the x-ray source 12. The beam center axes S of the different projection directions lie in such cases in a common examination plane E and generally intersect an examination center, also referred to as an isocenter.

The projection data sets detected by means of the x-ray detector 14 are fed directly to a data processing unit 18 by the x-ray detector 14. Alternately the detected projection data sets can be fed into the data processing unit 18 via the controller 17. In the data processing unit 18 the projection data sets are stored, and subsequently an associated three-dimensional image data set is determined from the detected projection data sets. The rate at which the image data sets are determined is referred to as the image determination rate and depends on the rate of projection data set detection and the calculation time for reconstruction of the image data set. The projection data set detection rate should thus be set as high as possible and simultaneously a time-efficient reconstruction algorithm for the image data set to be reconstructed should be used. To enable a high detection rate to be guaranteed, the highest possible speed of rotation of the x-ray emitter 11 and of the x-ray detector 14 as well as a high image recording rate are necessary. After determination of the three-dimensional image data set a spatial representation of the determined image data set is undertaken at an input/output unit 19.

By continuously detecting projection data sets of the examination area 32 with the introduced part 21 of the medical instrument 20 the image data sets are updated with the image determination rate f. This enables the introduced part 21 of the medical instrument 20, especially of the introduced end 22, to be followed in a spatial representation of the examination area 32. The advance and withdrawal of the puncture needle 20 can thus be controlled precisely. In particular it can be assessed whether a first organ 35 disposed next to the vessel to be punctured 33 will be affected, e.g. penetrated, by the puncture needle if it is advanced any further. Likewise the spatial representation of the medical instrument 20 in the examination area 32 allows better assessment of whether the vessel to be punctured 33 is reached with the end 22 of the puncture needle 20 or whether the attempt has failed. For this purpose there can be provision for an additional free rotation of the spatially represented examination area 32 with the introduced part 21 of the medical instrument 20 at an input/output unit. A high image determination rate can be used to ensure that the medical instrument 20 can be guided quickly and in a safely controlled manner.

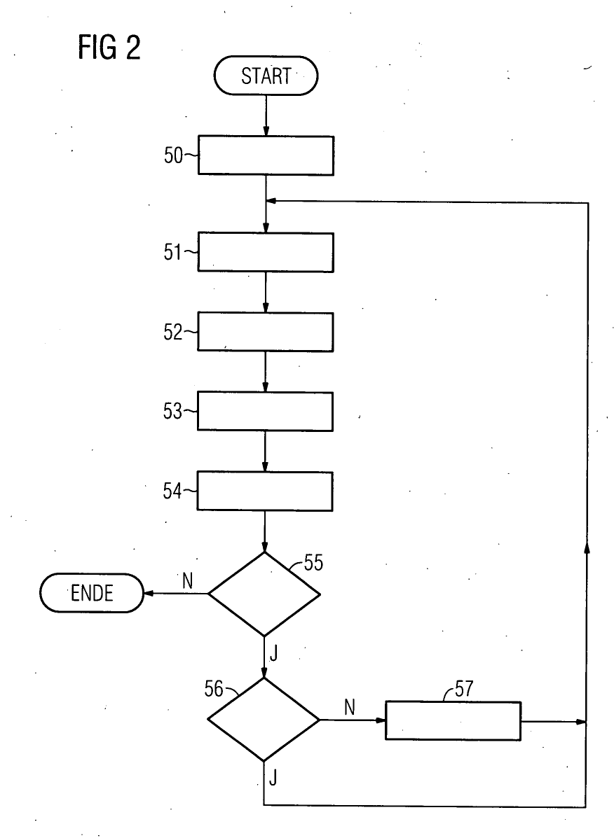

The method steps according to FIG. 2 are explained in conjunction with the device shown in FIG. 1 with reference symbols of apparatus components relating to FIG. 1. The flowchart presented in FIG. 2 shows a typical embodiment of the inventive method. In a first step 50 of the method, the examination environment 31 is defined by the medical personnel and the focusing device 13 for creating a focused x-ray beam X′ is adjusted so that is rays pass through the defined examination environment 31. The breast-stomach area of a patient 30 is defined as the examination environment 31 in this case, if the vessel 30 or organ 31 contained within it is to be punctured. It may possibly be that a setting of the focusing device 13 is not required.

Subsequently, in a next step 51, by rotating the C-arm 15 around the examination environment 31 and irradiating the examination environment 31 with the x-ray beam X or X′, a plurality of projection data sets are detected from different projection directions. Any movement of the C-arm 15 around the examination environment 31 can be selected, however it must be such that, after detection or recording of the projection data sets of the examination environment 31, a reconstruction of a three-dimensional image data set of the examination environment 31 can be determined. As a rule the medical instrument 20 is not introduced into the examination area 32 during detection of the examination environment 31. A three-dimensional image data set is determined from a plurality of two-dimensional projection data sets in a further step 52. Method step 52 is followed by a method step 53, in which an image data set determined beforehand is overlaid with the image data set currently determined. In the first determination of an image data set, e.g. for the examination environment 31, no overlaid presentation is determined since no data set determined beforehand exists. Subsequently a spatial representation of the overlaid image data set or of the examination environment 31 at an input/output unit 19 is undertaken in a method step 54.

The one-off determination of an image data set is thus completed. The determination of further image data sets is queried in a method step 55. For as long as an intervention is being performed, the determination of further image data sets is worthwhile. In a further method step 56 the invention queries whether the area through which the x-ray beam X′ is able to pass still coincides with the desired examination area 32. After determination of the spatial representation of the examination environment 31 this will not be the case, since the x-ray beam X′ or X is not passing through the examination area 32, but through the examination environment 31. Thus in a further step 57 the setting of the x-ray beam X′ or X is adapted such that the beam passes through the desired examination area 32. Subsequently a new detection of the projection data sets is undertaken according to method step 51. If, according to method step 56, the area able to be x-rayed still coincides with the desired examination area 32, method step 57 is skipped, and a new detection of the projection data sets is undertaken with unchanged x-ray beam setting according to method step 51.

If a change in the x-ray beam setting according to method step 56 and 57 is necessary, the examination environment 31 shown on the input/output unit 19 can be used. It is worthwhile in this case for the input/output unit to be embodied as a touch screen 19, so that a first limit position P1 and a second limit position P2 for the examination area 32 can be selected in the spatial representation of the examination environment 31 on the touch screen 19. The graphically selected limit positions P1 or P2 are fed to the data processing unit 18, which, from the marked limit positions P1 or P2 in the spatial representation of the examination environment 31, determines the setting parameters for the focusing device 13. The setting parameters are fed to the controller 17 which, with the aid of the controlled drive 16 or of a further drive not shown, makes the setting of the focusing device 13 and thereby of the x-ray beam X. The process of setting the x-ray beam X or of the examination area 32 is advantageously shown overlaid graphically onto the spatial representation of the examination environment 31, so that the medical personnel can verify or correct the limit positions P1 or P2. This can for example be performed such that the beam delimitating surface F of the focused x-ray beam X′ is calculated from the setting of the opening of the focusing device, and is shown in the spatial representation of the examination environment 31 in the correct location and/or orientation.

Once the examination area 32 or the setting of the focused x-ray beam X′ has been performed correctly, the medical intervention is started. To this end the puncture needle 20 is gradually introduced into the examination area 32 and is navigated in the direction of the vessel 33 to be punctured. When this is done spatial representations of the examination area 32 with the partly introduced puncture needle 20 are determined with the image determination rate in accordance with method steps 51 to 54. If necessary after method step 54, but before method step 51 is executed again, a method step 57 is performed, to adapt the x-ray beam setting to the progress of the medical intervention, especially the position and orientation of the introduced part 21 of the medical instrument 20.

Preferably the image determination rate is located within a range of several images per second, to enable the position and/or orientation of the introduced part of the medical instrument 20 to be determined in real time and without waiting times during the introduction of the instrument 20. The advance and withdrawal of the medical instrument 20 should always be performed matched to the image determination rate to make the operation safer for the examination object 30. To this extent, if the image determination rate is low, the medical personal can as a rule only work slowly. However the image determination rate can deliberately be kept low to reduce the radiation load for the object under examination 30, since fewer projection data sets are detected per unit of time.

A low image determination rate can however be partly compensated for by, in individual cases, not determining any spatial representation of the examination area 32 in order to assess the position and/or orientation of the medical instrument 20 with regard to the anatomical circumstances 33 or 34, but instead only a two-dimensional projection of the examination area 32 with introduced part 21 of the medical instrument 20. This projection data set can be overlaid on the spatially presented examination environment 31 or the previously determined spatial representation of the examination area 32 without any greater delay.

The determination of the examination area 32 and the associated setting of the x-ray beam X can also be coupled with a preferably automatic localization method for the medical instrument 20. The advantage of such a method lies in the fact that the selection of the examination area 32 after each reconstruction of a three-dimensional image data set can be automated, and for example the end 22 of the medical instrument 20 can always be found in the center of the determined spatial representation, although the end 22 of the medical instrument 20 is being continuously pushed forwards in the examination area 32. A good idea here is to use an image-based localization method which employs the projection data sets already detected and the determined image data sets for localization of the medical instrument 20 in the object under examination 30. To this end the position and/or orientation of the medical instrument 20 determined by means of the localization method is fed to the controller 17, which adapts the setting of the x-ray beam X, e.g. the movement of the C-arm 15, changed x-ray beam collimation/setting through the focusing device 13 by means of the controlled drive to the position and/or orientation of the medical instrument 20.

The method is expediently performed in accordance with the method steps 51 to 54 and where necessary an intermediate step 57 between step 54 and 51 until such time as the medical intervention is completed. The query as to whether the examination area is still set correctly is undertaken with method step 56.

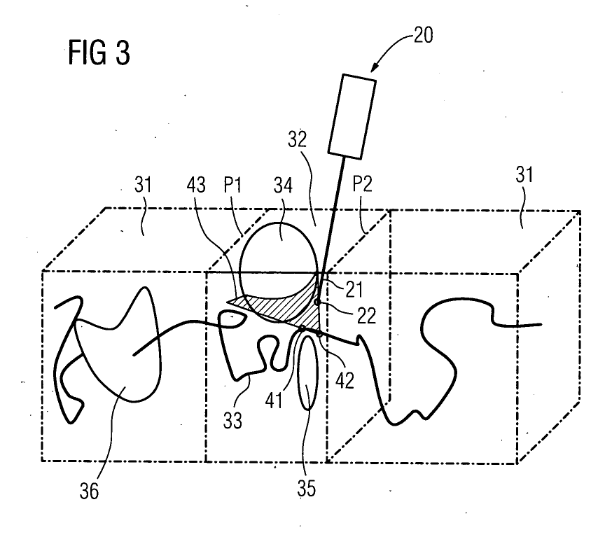

FIG. 3 shows a spatial representation of a three-dimensional image data set of the examination environment 31 and of the examination area 32 with a partly introduced medical instrument 20. The spatial representation of the examination area 32 is overlaid onto the spatial representation of the examination environment 31. The examination area features a first organ 34 and a second organ 35, which are arranged in the vicinity of the vessel 33 to be punctured. The examination environment 31 further features the spatial continuation of the vessel to be punctured 33 as well as a further third organ 36. The expanded spatial representation of the examination area 32 in the form of the examination environment 31 improves the orientation of the specialist medical personnel.

For improved targeting of the medical instrument 20 in the target section of the vessel to be punctured 33, two points 41 or 42 marking the target section of the vessel to be punctured can advantageously be marked in the spatial representation of the examination area 32 or examination environment 31. A third point is defined by the end 22 of the medical instrument 20. With the aid of these three points a plane 43 is determined which is overlaid onto the spatial representation of the examination area 32 or of the examination environment 31. The part of the plane 43 depicted can pass through the entire examination area 32 in order to improve the orientation for the medical personnel. This means that the direction in which the introduced part 21 of the medical instrument 20 is to be advanced in order to reach the target section can be better estimated by the medical personnel. Furthermore organs, for example the first organ 34 or the second organ 35, which are arranged between the target section of the vessel to be punctured 33 and the introduced end 22 of the medical instrument, are easier to recognize for the medical personnel. This means that the medical instrument 20 can be better navigated around organs which are not to be injured—such as the first organ 34—in the examination area 32.

The examination area 32 is updated in this case with the image determination rate and shown overlaid onto the spatial representation of the examination environment 31. The examination environment 31 is as a rule determined once at the beginning of the medical intervention. Should movements of the object under examination 30 occur during the intervention, and thus the examination area 32 of the examination environment 31 no longer be free from artifacts, i.e. not able to be overlaid with the correct location or orientation, such artifacts can be removed by means of the method of image registration. This means that the object under examination 30 is not subjected to any further radiation load. However additional computing steps are necessary in the data processing unit 18 to remove the artifacts in the overlaid spatial representation of the examination environment 31 and examination area 32. Alternately a new spatial representation of the examination environment 31 can be determined.

1.-12. (canceled)

13. A method for graphically following a movement of a medical instrument at least partly introduced into an object under examination, comprising:
penetrating an examination area of the object with an x-ray beam, wherein the x-ray beam comprises a beam center axis extending in a projection direction and is delimited by a beam delimiting surface;
detecting a two-dimensional projection data set of the examination area from the x-ray beam;
guiding the movement of the medical instrument introduced into the examination area with the projection data set;
determining a three-dimensional image data set of the examination area comprising a part of the medical instrument introduced into the examination area based on the two-dimensional projection data set by an image reconstruction method; and
graphically displaying the three-dimensional image data set,
wherein a plurality of three-dimensional image data sets comprising the part of the medical instrument introduced into the examination area are successively determined at an image determination rate and the image determination rate is selected such that the movement of the medical instrument can be followed.

14. The method as claimed in claim 13, wherein the beam center axis locates in a common plane of an examination plane penetrating the examination area.

15. The method as claimed in claim 13, wherein the part of the medical instrument introduced into the examination area comprises an end of the medical instrument.

16. The method as claimed in claim 13, wherein the x-ray beam is adjusted so that the beam delimiting surface tightly encloses the part of the medical instrument introduced into the examination area.

17. The method as claimed in claim 13, wherein the x-ray beam has a shape selected from the group consisting of: conical, wedge, and pyramid.

18. The method as claimed in claim 13, wherein a three-dimensional image data set of an examination environment of the object surrounding the examination area is determined and is overlaid with the successively determined three-dimensional image data sets of the examination area.

19. The method as claimed in claim 13, wherein a further two-dimensional projection data set of the examination area is detected after a last of the successively determined three-dimensional image data sets is determined and is overlaid with the last of the successively determined three-dimensional image data set.

20. The method as claimed in claim 13, wherein the x-ray beam is adjusted so that the beam delimiting surface encloses approximately through a limit position that is previously marked in a detected projection data set or a determined image data set.

21. The method as claimed in claim 13, wherein a setting of the x-ray beam is adapted to a current position or orientation of the medical instrument.

22. The method as claimed in claim 13, wherein a plane of the examination area is defined by a current position of the end of the medical instrument introduced into the examination area and by two points selected from a determined image data set or a detected projection data set.

23. The method as claimed in claim 22, wherein the three-dimensional image data set of the examination area is overlaid with the plane the examination area.

24. An apparatus for graphically following a movement of a medical instrument at least partly introduced into an object under examination, comprising:
an x-ray source that emits an x-ray beam, wherein the x-ray beam comprises a beam center axis extending in a projection direction and is delimited by a beam delimiting surface;
an x-ray detector that detects a two-dimensional projection data set of an examination area of the object;
a focusing device arranged between the x-ray source and the x-ray detector that focus and restricts the x-ray beam into an x-ray beam component penetrating the examination area of the object;
a data processing unit that determines a three-dimensional image data set of the examination area comprising a part of the medical instrument introduced into the examination area based on the two-dimensional projection data set; and
a display unit that displays the three-dimensional image data set of the examination area,
wherein a plurality of three-dimensional image data sets of the examination area comprising the part of the medical instrument introduced into the examination area are successively determined at an image determination rate and the image determination rate is selected such that the movement of the medical instrument can be followed.

25. The apparatus as claimed in claim 24, further comprising:
a C-arm where the x-ray source and the x-ray detector are located,
a drive unit that drives the C-arm to rotate around the examination area,
a controller that controls the drive unit and a setting of the focusing device.

26. The apparatus as claimed in claim 25, wherein the setting of the focusing device is adjusted for restricting the x-ray beam into the x-ray beam component penetrating the examination area of the object.

27. The apparatus as claimed in claim 24, wherein the x-ray beam is adjusted so that the beam delimiting surface tightly encloses the part of the medical instrument introduced into the examination area.

28. The apparatus as claimed in claim 24, wherein the x-ray beam is adjusted so that the beam delimiting surface encloses approximately through a limit position that is previously marked in a detected projection data set or a determined image data set.
